(19) United States
(12) Patent Application Publication
(10) Pub. No.: US 2026/0250994 A1
(43) Pub. Date: Aug. 27, 2026

(54) OUTSIDE DOOR HANDLE DEVICE

(71) Applicant: TOYOTA JIDOSHA KABUSHIKI KAISHA, Aichi-ken (JP)

(72) Inventor: Yoshiro TAKIGAMI, Toyota-shi (JP)

(21) Appl. No.: 19/406,938

(22) Filed: Dec. 3, 2025

(30) Foreign Application Priority Data
Feb. 26, 2025 (JP) 2025-028713

(51) Int. Cl. E05B 85/16

(52) U.S. Cl. CPC E05B 85/16

(57) ABSTRACT

The outside door handle device comprises a rod, a bell crank, and an operation arm. The rod is configured to rotate a door latch. The bell crank has a point-of-load arm. The point-of-load arm is connected to the rod. The operation arm is configured to rotate the bell crank. The operation arm comprises an arm part, a rotation shaft, and a lever. The arm part faces a point-of-effort arm of the bell crank along an advancement/retreat direction of the point-of-effort arm. The rotation shaft is provided at one end of the arm part. The lever is provided at the other end of the arm part and exposed to an outside of the vehicle.

### CROSS REFERENCE TO RELATED APPLICATION

This application claims priority to Japanese Patent Application No. 2025-28713 filed on Feb. 26, 2025, which is incorporated herein by reference in its entirety including the specification, claims, drawings, and abstract.

### TECHNICAL FIELD

The present specification discloses an outside door handle device for a vehicle.

### BACKGROUND

The vehicle door is provided with an outside door handle. JP 2022-151859 discloses a flap-type outside door handle. The door panel is provided with an opening. A flap is provided inside the opening. When opening the door, the user's finger is inserted into the opening. The door is then opened by pushing the flap with a finger.

When a member such as a flap or a lever is small, the number of fingers that can be hooked on the member is limited. Therefore, the present specification discloses an outside door handle device capable of reducing a load at the time of operation as compared with the related art.

### SUMMARY

The present specification discloses an outside door handle device. The outside door handle device comprises a rod, a bell crank, and an operation arm. The rod is configured to rotate a door latch. The bell crank has a point-of-load arm. The point-of-load arm is connected to the rod. The operation arm is configured to rotate the bell crank. The operation arm comprises an arm part, a rotation shaft, and a lever. The arm part faces a point-of-effort arm of the bell crank along an advancement/retreat direction of the point-of-effort arm. The rotation shaft is provided at one end of the arm part. The lever is provided at the other end of the arm part and exposed to an outside of the vehicle.

According to the above configuration, when the lever is operated, the bell crank rotates via the operation arm. Compared with the case where the bell crank is directly rotated, the load during lever operation is reduced by the principle of leverage.

In the above configuration, the lever may be disposed within an opening of a door outer panel. In this case, the opening of the door outer panel is an elongated hole along a vehicle front/rear direction. The lever is disposed at a rear portion of the elongated hole. The lever has a hook shape with a tip of the lever protruding forward. An exposed surface of the lever is inclined so that a front end thereof is located on an inner side in a vehicle width direction with respect to a rear end thereof.

Air may flow into the opening of the door outer panel while the vehicle is running. When the air flow enters the hook-shaped lever capable of being operated with a light load, the lever may float to the outside of the vehicle. Since the vehicle door is locked by the lock mechanism, the vehicle door does not open due to the lifting of the lever, but the aerodynamic characteristics of the vehicle may deteriorate due to the lifting of the lever. According to the above configuration, the air flow entering the opening is guided to the exposed surface of the lever and flows out of the vehicle.

Further, in the above configuration, a cover may be disposed within the elongated hole and behind the lever. In this case, an exposed surface of the cover is inclined so that a front end thereof is located on the inner side in the vehicle width direction with respect to a rear end thereof. The rear end of the exposed surface of the lever is connected to the front end of the exposed surface of the cover.

According to the above configuration, the air flow entering the opening of the door outer panel is smoothly guided to the outside of the vehicle by the exposed surfaces of the lever and the cover.

In the above configuration, a projection may be formed on a surface of the arm part facing the point-of-effort arm. In this case, a recessed portion is formed on the arm part on a side closer to the lever than the protrusion, and the recessed portion is separated from the point-of-effort arm.

According to the above configuration, the recessed portion is formed on the lever side of the arm portion having a relatively large stroke. Accordingly, the lever-side portion of the arm portion is prevented from interfering with the other member in the process in which the protrusion pushes the point-of-effort arm.

In the above configuration, a pictogram may be formed on the exposed surface of the lever.

According to the above configuration, when the lever is the door opening/closing means in the emergency, the driver or the like can quickly recognize the presence of the lever by the pictogram.

According to the outside door handle device disclosed in the present specification, the load at the time of operation can be reduced as compared with the prior devices.

### BRIEF DESCRIPTION OF DRAWINGS

Embodiments of the present disclosure will be described based on the following figures, wherein:

FIG. 1 is a side view of a vehicle illustrating an outside door handle device according to the present embodiment;

FIG. 2 is a cross-sectional view taken along line A-A of FIG. 1;

FIG. 3 is a cross-sectional view taken along line B-B of FIG. 1;

FIG. 4 is a view showing an example in which a cover is removed to expose a mechanical key cylinder;

FIG. 5 is a view for explaining a structure of a bell crank and an operation arm (however, a structure of a left door is illustrated in this figure);

FIG. 6 is an enlarged view of a cross-sectional view taken along line B-B of FIG. 1;

FIG. 7 is a view (1/2) illustrating the operation of the operation arm and the bell crank; and

FIG. 8 is a diagram (2/2) illustrating the operation of the operation arm and the bell crank.

### DESCRIPTION OF EMBODIMENTS

Hereinafter, an outside door handle device according to the present embodiment will be described with reference to the drawings. The shapes, materials, numbers, and numerical values described below are for illustrative purposes only. These shapes and the like can be appropriately changed according to the specifications of the outside door handle device. In addition, in the following description, the same reference numerals denote the same elements in all the drawings.

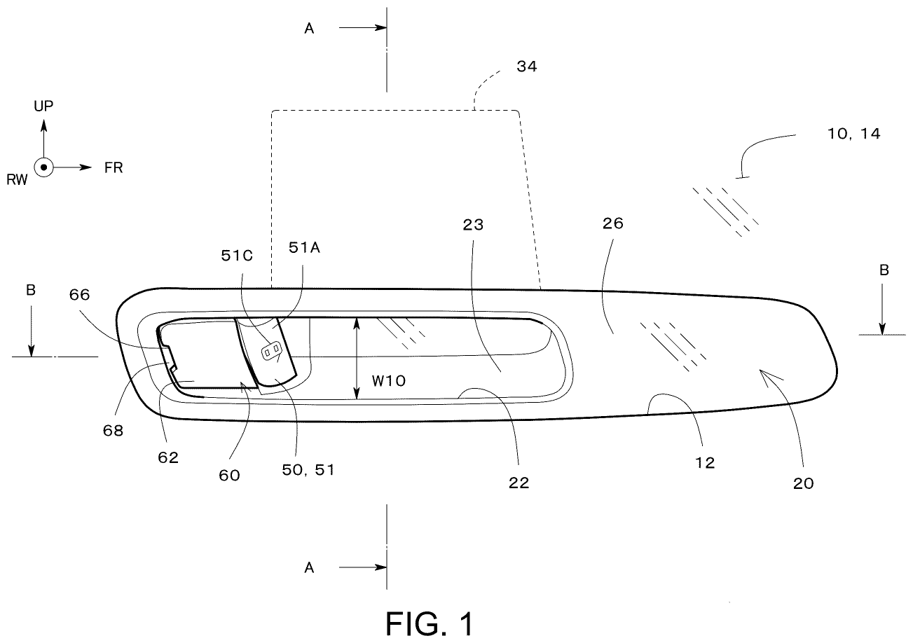

In FIGS. 1 to 8, an orthogonal coordinate system including an FR axis, an RW axis, and an UP axis is used to represent the position and direction of each configuration. The FR axis is a vehicle longitudinal axis. The RW axis is a vehicle width direction axis. The UP axis is a vehicle vertical axis. The forward direction of the FR axis is defined as the forward direction. The right side of the vehicle is defined as the forward direction of the RW axis. The upward direction of the UP axis is defined as a positive direction.

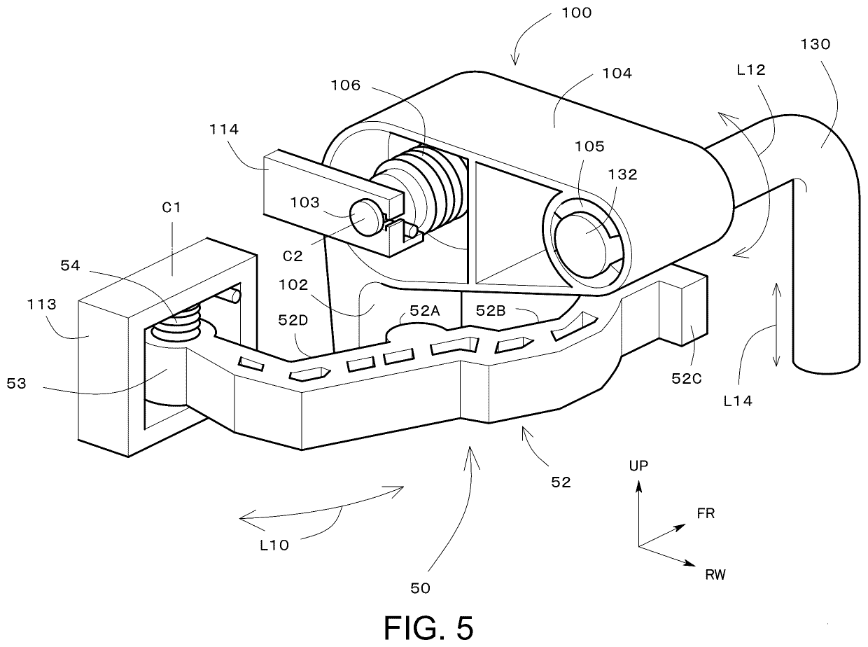

The outside door handle device according to the present embodiment is provided in a driver's seat door of a vehicle. FIG. 1 to FIG. 4 and FIG. 6 to FIG. 8 illustrate an outside door handle device installed in the right door. FIG. 5 also shows an outside door handle device installed in the left door.

As described in detail below, the outside door handle device according to the present embodiment includes a rod 130 (see FIG. 5), a bell crank 100, and an operation arm 50.

### 1. Vehicle Side Surface

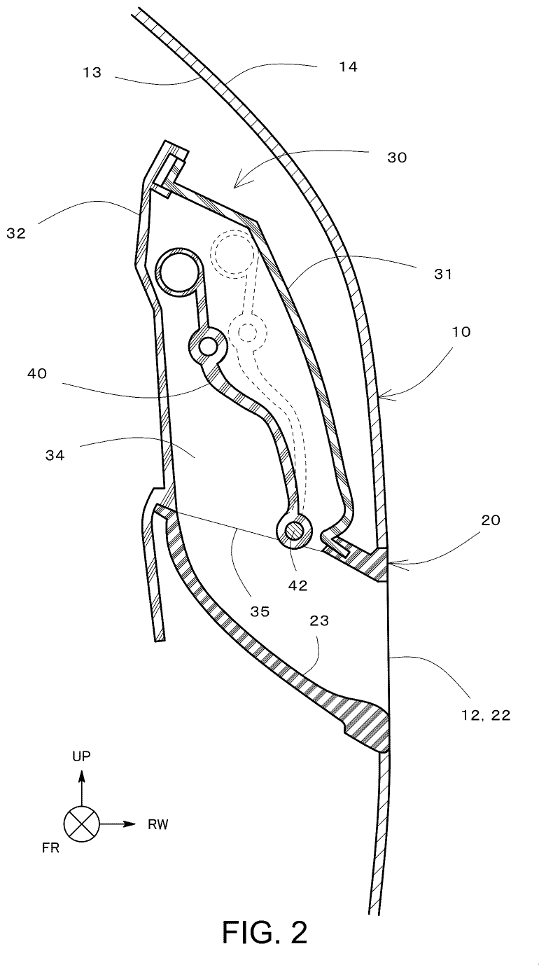

FIG. 1 illustrates a side view of a vehicle. More particularly, an enlarged view of the right vehicle door is illustrated in FIG. 1. The door outer panel 10 is provided on the vehicle door as a panel member on the exposed surface (outer surface) side of the vehicle door. As described later, the door outer panel 10 is provided with a door handle 40 (see FIG. 2) of an electric opening and closing mechanism. The door outer panel 10 is provided with a lever 51 of a mechanical opening/closing mechanism.

FIG. 2 illustrates an A-A cross section of FIG. 1. The door outer panel 10 is made of a metal material or a resin material such as CFRP. The door outer panel 10 includes an exposed surface 14 and an inner surface 13. The exposed surface 14 is exposed to the outside. The inner surface 13 is opposite to the exposed surface 14. The inner surface 13 faces a door inner panel (not shown).

A space is provided in the vehicle door by the door outer panel 10 and the door inner panel (not shown). In this space, an electric opening/closing mechanism illustrated in FIG. 2 is disposed.

Referring to FIG. 1, an opening is formed in the door outer panel 10. As the opening, an elongated hole 12 is formed in the door outer panel 10. The longitudinal direction of the elongated hole 12 is the vehicle longitudinal direction. The garnish 20 is fitted into the elongated hole 12. The garnish 20 includes an exposed surface 26 and an opening 22. The exposed surface 26 is disposed on the same plane as the exposed surface 14 of the door outer panel 10. An opening 22 is formed in the exposed surface 26 at a position rearward in the vehicle front-rear direction. An electric opening/closing mechanism and a mechanical opening/closing mechanism are disposed in the opening 22. Detailed structures of the electric opening/closing mechanism and the mechanical opening/closing mechanism will be described later.

The width W10 of the opening 22 is, for example, a width in which the hand can be horizontally inserted. Therefore, when pulling the lever 51 provided in the opening 22, the user hooks the lever 51 with, for example, about one finger or two fingers. As described above, since the number of fingers hooked on the lever 51 is small, the lever 51 can be pulled with a light load as described later.

The garnish 20 comprises a guide surface 23 connecting with the opening 22. The guide surface 23 is connected to the lower edge of the opening 22. With reference to FIG. 2, the guide surface 23 has an upward inclined structure that is directed upward toward the inner side in the vehicle width direction.

When the hand is inserted into the opening 22, the fingertip is guided upward along the guide surface 23. That is, the fingertip is guided into the operation space 34 along the guide surface 23. When a finger touches the door handle 40 in the operation space 34, the door handle 40 is operated.

### 2. Electric Opening/Closing Mechanism

Referring to FIGS. 1 and 2, the vehicle door is provided with an electric opening/closing mechanism. The electric opening/closing mechanism includes a housing 30 and a door handle 40.

An opening 35 is formed at the lower end of the housing 30. The opening 35 of the housing 30 is connected to the opening 22 of the garnish 20. The housing 30 extends upward from the opening 35. For example, the housing 30 has an inverted U-shaped cross-sectional shape in the A-A cross section (FIG. 2). For example, the housing 30 includes a housing outer 31 and a housing inner 32.

The internal space of the housing 30 serves as an operation space 34. A door handle 40 is disposed in the operation space 34. The door handle 40 is rotatable about a shaft 42 as a rotation axis. The shaft 42 extends in the vehicle front-rear direction. Therefore, the door handle 40 swings along the vehicle width direction between the basic position indicated by the solid line and the abutting position indicated by the broken line. At the contact position, the door handle 40 contacts the housing outer 31.

When the door handle 40 is moved from the basic position to the abutment position, the vehicle door is opened by an electrical unlocking operation. Since this unlocking operation is known, the description thereof will be omitted.

### 3. Mechanical Opening/Closing Mechanism

The outside door handle device according to the present embodiment includes a mechanical opening and closing mechanism. The mechanical opening/closing mechanism is a so-called emergency opening/closing mechanism. For example, the mechanical switching mechanism does not require power supply.

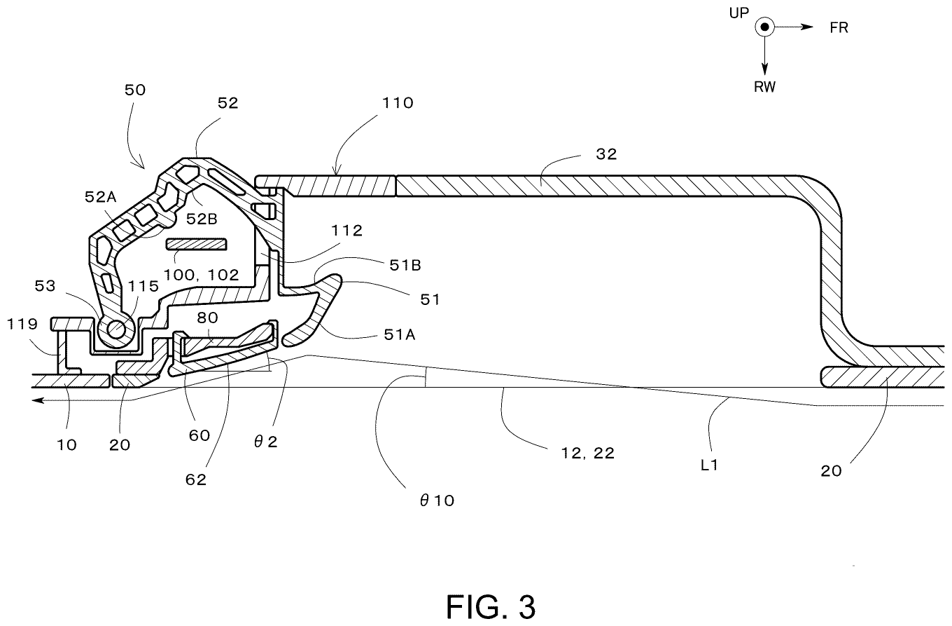

Referring to FIGS. 3, 4, and 5, the mechanical opening and closing mechanism includes the mechanical key cylinder 70, the operation arm 50, the bell crank 100, the rod 130, the cover 60, the base 80, and the holder 110. The lever 51, the mechanical key cylinder 70, the cover 60, the base 80, and the holder 110 of the operation arm 50 are disposed in the elongated hole 12 (that is, in the opening) of the door outer panel 10. More specifically, the lever 51, the mechanical key cylinder 70, the cover 60, the base 80, and the holder 110 are disposed in the opening 22 of the garnish 20.

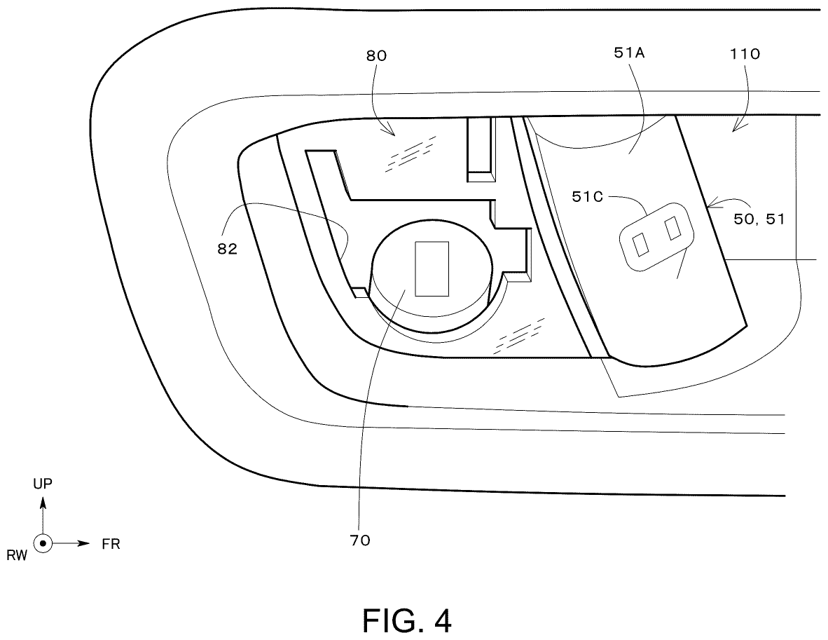

A mechanical key cylinder 70 is disposed at a rear end portion along the vehicle front-rear direction of the elongated hole 12 and the opening 22. For example, referring to FIG. 4, the mechanical key cylinder 70 is obliquely exposed from the opening 82 of the base 80. That is, the mechanical key cylinder 70 is disposed obliquely so as to extend downward toward the vehicle width direction inner side.

The mechanical key cylinder 70 switches between locking and unlocking of the vehicle door. For example, a mechanical key (not shown) is inserted into the mechanical key cylinder 70. Then, the mechanical key cylinder 70 is rotated by the mechanical key. At this time, the ratchet (not shown) engaged with the door latch (not shown) is disengaged from the door latch. That is, the door lock mechanism is switched from the locked state to the unlocked state.

In this unlocked state, the door latch rotates by actuating the rod 130 (see FIG. 5). Rotation of the door latch causes the door latch to disengage from the striker (not shown). As a result, the vehicle door is opened.

The cover 60 covers the mechanical key cylinder 70. The mechanical key cylinder 70 is disposed at a rear end portion of the elongated hole 12. Therefore, the cover 60 is also disposed at the rear end portion of the elongated hole 12.

The cover 60 includes an exposed surface 62. The exposed surface 62 is inclined so that the front end thereof is located on the inner side in the vehicle width direction with respect to the rear end thereof. The front end of the exposed surface 62 is connected to the rear end of the exposed surface 51A of the lever 51. Further, the rear end of the exposed surface 62 is connected to the garnish 20.

The cover 60 is engaged with the base 80. Referring to FIG. 1, a notch 66 is formed in the rear end of the cover 60. This notch forms an insertion hole 68 between the garnish 20 and the cover 60.

When the door is opened by the mechanical opening/closing mechanism, first, a mechanical key or a tool is inserted into the insertion hole 68. When the cover 60 is urged outward in the vehicle width direction, the cover 60 is detached from the base 80. As a result, the mechanical key cylinder 70 is exposed to the outside of the vehicle.

The lever 51 is disposed adjacent to the front of the cover 60. That is, the lever 51 is disposed at a rear portion of the elongated hole 12. As described later, an inclined surface is formed by the exposed surface 51A (see FIG. 3) of the lever 51 and the exposed surface 62 of the cover 60. The inclined surface functions as a guide surface that guides the air flowing into the opening 22 to the outside of the vehicle.

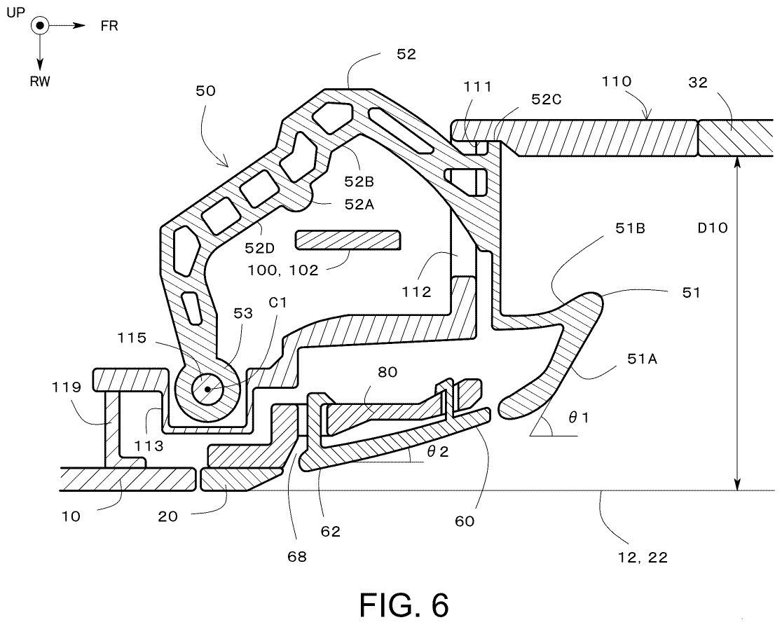

FIG. 6 illustrates an enlarged view of FIG. 3. The lever 51 includes an exposed surface 51A and an operation surface 51B. The exposed surface 51A is exposed to the outside of the vehicle. In addition, the exposed surface 51A is disposed so as to be inclined such that the front end is on the inner side in the vehicle width direction with respect to the rear end.

For example, the inclination angle θ1 of the front end portion of the exposed surface 51A is larger than the inclination angle θ2 of the exposed surface 62 of the cover 60 (θ1>θ2). That is, the front end of the exposed surface 51A extends deeply in the opening 22. For example, the tip of the lever 51 enters the elongated hole 12 to a depth of half or more of the depth D10 of the elongated hole 12. As described later, the air that has entered the opening 22 is scooped up by the exposed surface 51A and 62, and is discharged to the outside of the vehicle.

The operation surface 51B is connected to the front end of the exposed surface 51A. The operation surface 51B faces the housing inner 32 and the holder 110. That is, when the vehicle door is viewed from the side, the operation surface 51B is a hidden surface. The operator's finger comes into contact with the operation surface 51B.

As illustrated in FIG. 6, the lever 51 has a hook shape by the exposed surface 51A and the operation surface 51B. That is, the tip of the lever 51 protrudes forward.

When the vehicle is viewed from the side as shown in FIG. 1, only the exposed surface 51A of the lever 51 is visible. That is, it may be difficult to recognize that the lever 51 has a hook shape. Therefore, a pictogram 51C may be formed on the exposed surface 51A. For example, the pictogram 51C may be formed in a mold when the operation arm 50 is molded. By forming the pictogram 51C into a three-dimensional concavo-convex shape, the lever 51 can be found by hand even at night.

Referring to FIG. 3, holder 110 holds operation arm 50 and bell crank 100 (see FIG. 5). Referring to FIG. 3, the holder 110 is supported by, for example, the housing inner 32 and the door outer panel 10. For example, the holder 110 is supported by the door outer panel 10 via the bracket 119.

As described later, the holder 110 is provided with holding portions 113 and 114 (see FIG. 5). For example, holding portions 113 and 114 protrude from the plate surface of the holder 110. The holding portion 113 holds the operation arm 50. The holding portion 114 holds the bell crank 100.

### 4. Aerodynamic Properties of Mechanical Switching Mechanisms

Referring to FIGS. 3 and 6, an inclined surface is formed by the exposed surface 51A of the lever 51 and the exposed surface 62 of the cover 60. The inclined surface enters the vehicle width direction inner side toward the vehicle front side.

Since the inclined surface is formed at the rear end portion of the opening 22, the air entering the opening 22 is discharged to the outside of the vehicle. For example, while the vehicle is traveling at a high speed (e.g., 80 km/h or more), air as indicated by the flow L1 enters the opening 22. The air flow L1 is guided by the exposed surface 62 of the cover 60 and discharged to the outside of the vehicle.

Even when the inflow angle of the outside air exceeds the angle θ10 due to the external environment or the like, the exposed surface 51A of the lever 51 scoops the inflow air. The scooped air is sent to the exposed surface 62 of the cover 60 and discharged to the outside of the vehicle.

As described above, according to the outside door handle device of the present embodiment, the air flowing into the opening 22 during traveling of the vehicle is discharged to the outside of the vehicle by the lever 51 and the inclined surface of the cover 60. Therefore, stagnation of air in the opening 22 is suppressed.

Referring to FIG. 6, a gap is formed between operation surface 51B of lever 51 and holder 110. However, the flow of air entering the elongated hole 12 is guided to the outside of the vehicle by the inclined surface formed by the exposed surface 51A and the exposed surface 62. That is, the air flow is prevented from entering the gap between the operation surface 51B and the holder 110. This prevents the lever 51 from floating outward in the vehicle width direction.

As described later, the operation arm 50 according to the present embodiment enables an operation with a light load. The slope structure of the exposed surface 51A and 62 suppresses lifting of the lever 51 due to the air flow.

### 5. Door Opening Structure

FIGS. 5 and 6 illustrate a mechanism for opening the door. The opening mechanism includes the operation arm 50, the bell crank 100, and the rod 130. The upper end 132 of the rod 130 is coupled to the bell crank 100. More specifically, the upper end 132 of the rod 130 is slidably supported at the end of the point-of-action arm 104 of the bell crank 100 via the slide bearing 105.

The rod 130 moves up and down as illustrated by an arrow L14 in accordance with the rotation of the point-of-load arm 104 as illustrated by an arrow L12. A door lock mechanism (not shown) is coupled to a lower end of the rod 130. When the door lock mechanism is in the unlocked state, the rod 130 moves downward to rotate the door latch (not shown). Rotation of the door latch disengages the door latch from the striker (not shown) and opens the door.

The bell crank 100 is a boomerang crank member. The bell crank 100 is, for example, the first class lever. That is, the bell crank 100 includes a shaft 103 serving as a fulcrum between the point-of-effort arm 102 and the point-of-load arm 104.

The bell crank 100 rotates about a rotation axis C2. The rotation axis C2 is directed in the vehicle front-rear direction. The shaft 103 is provided along the rotation axis C2. The shaft 103 is slidably held by the holding portion 114. The holding portion 114 is a part of the holder 110 (see FIG. 6).

The shaft 103 is biased by a spring 106. As will be described later, the operation arm 50 rotates the bell crank 100 in a direction opposite to the biasing direction of the spring 106.

Referring to FIGS. 5 and 6, the operation arm 50 rotates the bell crank 100. The operation arm 50 includes the lever 51, the arm portion 52, and the bush 53. The operation arm 50 is provided with the bush 53 at one end of the arm portion 52. A rotation axis C1 is set in the bush 53. The rotation axis C1 is oriented in the vertical direction. The operation arm 50 rotates about the rotation axis C1 as indicated by an arrow L10.

Referring to FIG. 6, shaft 115 is provided along rotation axis C1. The shaft 115 is, for example, a part of the holder 110. The bush 53 is fitted into the shaft 115. The bush 53 is slidable relative to the shaft 115. The bush 53 is held by the holding portion 113. The holding portion 113 is a part of the holder 110.

The operation arm 50 is biased by the spring 54. Referring to FIG. 6, the arm portion 52 is provided with a seating protrusion 52C. The seating protrusion 52C is seated on the seating surface 111 of the holder 110 by the biasing force of the spring 54. The position of the operation arm 50 when the seating protrusion 52C is seated on the seating surface 111 is also referred to as an “original position”. As will be described later, the operation arm 50 rotates the bell crank 100 in a direction opposite to the biasing direction of the spring 54.

The lever 51 is provided at the other end of the arm portion 52 at which the bush 53 is provided at one end. That is, the arm portion 52 (more specifically, the protrusion 52A) serving as the point of load is provided between the lever 51 serving as the point of effort and the bush 53 serving as the fulcrum. In this way, the operation arm 50 is composed of, for example, the second class lever.

The lever 51 of the operation arm 50 is disposed in the elongated hole 12. Referring to FIG. 6, a slit 112 is formed in the holder 110. The slit 112 is formed, for example, across the vehicle width direction. The operation arm 50 is disposed so as to straddle the slit 112.

The arm portion 52 extends along a path that avoids the bell crank 100. For example, the lever 51 and the bush 53 are disposed on the vehicle width direction outer side of the point-of-effort arm 102 of the bell crank 100. The arm portion 52 extends from the bush 53 to the lever 51 in a substantially arc shape so as to surround the point-of-effort arm 102.

The arm portion 52 is made of, for example, a resin material such as plastic. In order to reduce the weight, a plurality of through holes are formed in the arm portion 52. The arm portion 52 faces the point-of-effort arm 102 along the forward/backward direction of the point-of-effort arm 102 of the bell crank 100. The arm portion 52 is provided with a surface 52D facing the point-of-effort arm 102. A protrusion 52A is formed on the facing surface 52D. As will be described later, the protrusion 52A of the arm portion 52 may be exclusively in contact with the point-of-effort arm 102.

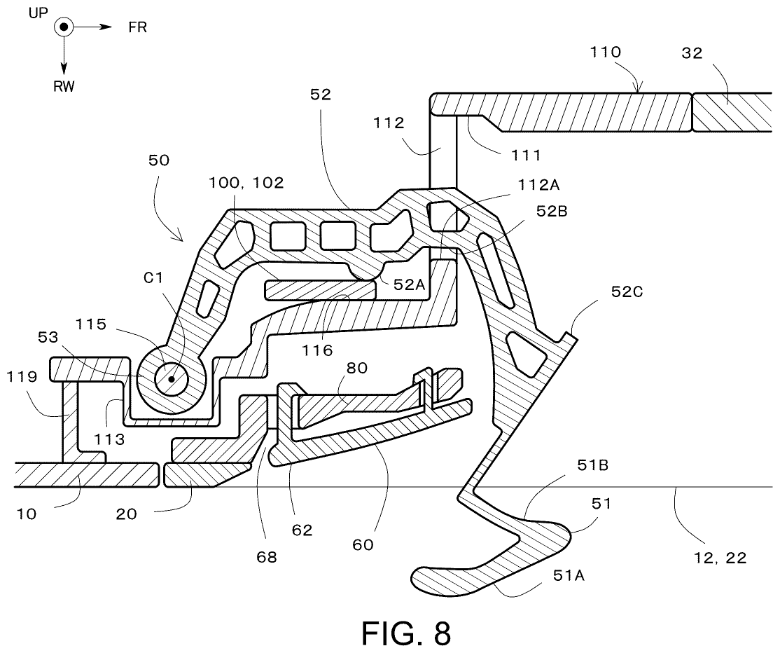

Further, a recess 52B is formed in the facing surface 52D. The recess 52B is provided closer to the lever 51 than the protrusion 52A. The recess 52B is bulges in a direction away from the point-of-effort arm 102. As shown in FIG. 8 to be described later, in a state where the point-of-effort arm 102 abuts against the contact surface 116 of the holder 110, the recess 52B faces the edge 112A of the slit 112. At this time, since the recess 52B and the edge 112A are separated from each other, the point-of-effort arm 102 can be reliably brought into contact with the contact surface 116.

### 6. Opening Door by Mechanical Opening and Closing Mechanism

Referring to FIGS. 1 and 4, when cover 60 is removed, mechanical key cylinder 70 is exposed to the outside of the vehicle. Further, a mechanical key is inserted into the mechanical key cylinder 70. When the key cylinder is rotated by the mechanical key, the ratchet (not shown) is disengaged from the door latch (not shown). That is, the door lock mechanism is in the unlocked state.

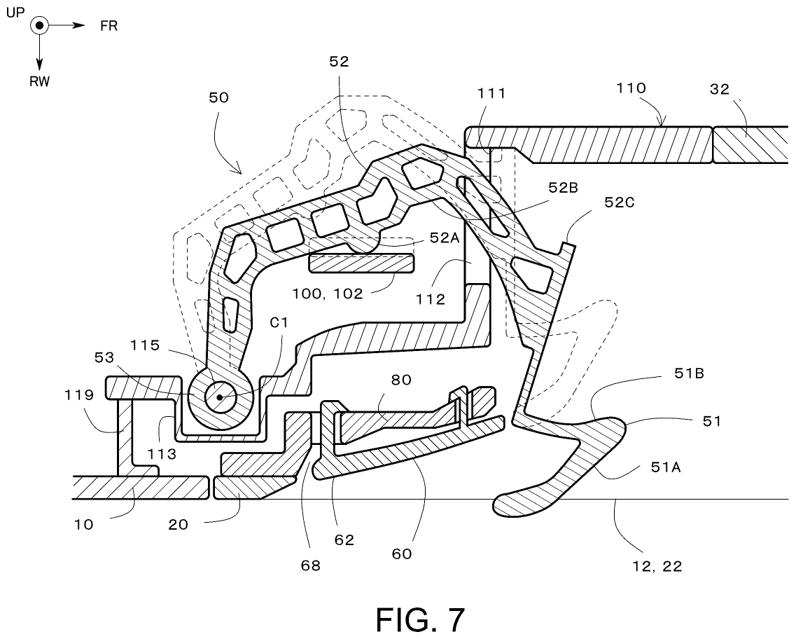

In this state, the lever 51 is pulled outward in the vehicle width direction. Referring to FIG. 7, as lever 51 is pulled, protrusion 52A of operation arm 50 pushes point-of-effort arm 102 of bell crank 100 outward in the vehicle width direction. As a result, the bell crank 100 (see FIG. 5) rotates clockwise about the rotation axis C2. As the bell crank 100 rotates, the rod 130 is pulled downward.

In this way, the bell crank 100 rotates on the principle of leverage by the operation arm 50. As compared with the case where the bell crank 100 is directly rotated, the load during operation is reduced.

Referring to FIG. 8, when the lever 51 is pulled outward in the vehicle width direction, the point-of-effort arm 102 abuts against the contact surface 116 of the holder 110. At this time, the rod (see FIG. 5) is pulled down to the lowest end. Accordingly, the door latch is disengaged from the striker. As a result, the door is opened.

The present disclosure is not limited to the embodiments described above, and may embrace all changes and modifications without departing from the technical scope or the essence of the present disclosure defined by the claims.

1. An outside door handle device comprising:
a rod configured to rotate a door latch;
a bell crank having a point-of-load arm to which the rod is connected;
an operation arm configured to rotate the bell crank; wherein the operation arm comprises:
an arm part facing a point-of-effort arm of the bell crank along an advancement/retreat direction of the point-of-effort arm;
a rotation shaft provided at one end of the arm part; and
a lever provided at the other end of the arm part and exposed to an outside of the vehicle.

2. The outside door handle device according to claim 1, wherein:
the lever is disposed within an opening of a door outer panel;
the opening of the door outer panel is an elongated hole along a vehicle front/rear direction;
the lever is disposed at a rear portion of the elongated hole;
the lever has a hook shape with a tip of the lever protruding forward; and
an exposed surface of the lever is inclined so that a front end thereof is located on an inner side in a vehicle width direction with respect to a rear end thereof.

3. The outside door handle device according to claim 2, further comprising
a cover disposed within the elongated hole and behind the lever; wherein
an exposed surface of the cover is inclined so that a front end thereof is located on the inner side in the vehicle width direction with respect to a rear end thereof; and
the rear end of the exposed surface of the lever is connected to the front end of the exposed surface of the cover.

4. The outside door handle device according to claim 1, wherein:
a protrusion is formed on a surface of the arm part facing the point-of-effort arm; and
a recessed portion is formed on the arm part on a side closer to the lever than the protrusion, and the recessed portion is separated from the point-of-effort arm.

5. The outside door handle device according to claim 1, wherein a pictogram is formed on the exposed surface of the lever.
